(19) United States
(12) Patent Application Publication
(10) Pub. No.: US 2014/0263461 A1
(43) Pub. Date: Sep. 18, 2014

(54) MOTORIZED AERATOR POURER

(71) Applicant: David M. Prokop, (US)

(72) Inventor: David M. Prokop, Sammamish, WA (US)

(73) Assignee: David M. Prokop, Sammamish, WA (US)

(21) Appl. No.: 13/800,390

(22) Filed: Mar. 13, 2013

(51) Int. Cl. B67D 7/76

(52) U.S. Cl. CPC B01F 3/0446
USPC 222/190

(57) ABSTRACT

A motorized aerator pourer for mixing oxygen with certain liquids such as wine, spirits, water and preventing dripping of the liquid after being poured from a container. The motorized aerator pourer includes a pouring spout assembly being removably engaged to a container for pouring liquid from a container. The assembly includes a motorized aerating component being attached to the pouring spout assembly for mechanically aerating the liquid as it is being poured from a container.

### TECHNICAL FIELD

The present invention relates to liquid aerators and more particularly to a new motorized aerator pourer for mixing air with the liquid.

### BACKGROUND

The use of bottle pourers is known in the prior art. More specifically, bottle pourers are known to consist of a funnel like function, where the liquid is poured from a bottle through the funnel like device and into a receiving glass. There are many variations on this theme to use venturi geometric shape principles to introduce air into the liquid stream. Other conventional devices use shape surface geometry to increase the surface area of the funnel like device to increase the surface area of the liquid exposed to the air to increase the rate of oxidation of the liquid.

Other prior art devices includes liquid pourers having spouts inserted into a bottle with hoses connected to the aerator for allowing air into the bottle. While these devices provide some benefits, there is a need for improved aerator assemblies usable with liquids, including consumable liquids such as wine, fruit, beverages, water, alcohol, spirits, or other beverages.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a motorized aerator bottle pourer assembly in accordance with at least one embodiment of the present disclosure.

FIG. 2 is a cross-sectional view taken along lines 2-2 of FIG. 1.

FIG. 3 is a top plan view of the assembly of FIG. 1.

FIG. 4 is a bottom plan view of the assembly of FIG. 1.

FIGS. 5 and 6 are side elevation views of the assembly of FIG. 1.

FIG. 7 is a rear elevation view of the assembly of FIG. 1.

FIG. 8 is a front elevation view of the assembly of FIG. 1.

FIG. 9 is a cross-sectional view of a motorized aerator assembly in accordance with another embodiment of the present disclosure.

FIG. 10 is a partially exploded side elevation view of the assembly of FIG. 9.

FIG. 11 is a front elevation view of the assembly of FIG. 9.

### DETAILED DESCRIPTION

Embodiments in accordance with the present disclosure are set forth hereinafter to provide a thorough understanding and enabling description of a number of particular embodiments. A person skilled in the art will understand, however, that the invention may have additional embodiments, or that the invention may be practiced without one or more of the specific details of the embodiments as shown and described.

Several embodiments of the technology are directed to motorized aerator assembly for mixing air with a liquid while being poured. One embodiment provides a motorized aerator assembly configured to aggressively aerate liquid to oxidize certain flavor compounds, release dissolved gases like sulfur dioxide or release other volatile components from wine, although the assembly is also useable with other liquids, such as water, alcohol, etc. The motorized aerator pourer allows liquids to pass through spinning members which will mix the liquid with air and propel the liquid from the spout exit into a glass or other receiving receptacle.

In at least one embodiment, a motorized aerator pourer comprises a pouring assembly removably engageable to a container for pouring liquids from a container. The pouring assembly has a liquid inlet, a liquid outlet, and a spout portion that defines a liquid passageway through which a flow of the liquid and air is passed. A propeller with a plurality of propeller blades is rotatably disposed in the spout within the liquid passageway in position to engage the flow of liquid moving through the spout toward the liquid outlet. The propeller is operatively connected to a drive member, such as an electric motor, that spins the propeller at sufficient rate of rotation relative to the spout and the flow of liquid to cause the air to aggressively mix with the liquid in the flow of liquid prior to exiting the spout through the liquid outlet.

In one embodiment, the propeller has in the range of 1 to 10 propeller blades. The motor may be powered by one or more batteries, rechargeable batteries or capacitor. The motor may be controlled by tilt switch activated upon tilting of the pouring assembly relative to vertical. The assembly can include one or more lights, such as a LED light. The light may be, coupled to and controllable by an on-off switch and/or the tilt switch. The assembly can have a housing portion that contains the electric motor and that has at least one wall portion with the liquid inlet therein. The housing portion is configured to sealably engage the container to allow liquid from the container to be passed through the liquid inlet and spout portion toward the liquid outlet. The housing portion may have a threaded portion configured to threadably engage a portion a mating threaded portion of the container. The spout portion defines an air mixing chamber therein. The assembly can include one or more openings in the spout portion to facilitate cleaning of the air mixing chamber and/or the spout portion. The assembly can include a cap removably disposed over at least one of the liquid inlet port liquid outlet to prevent liquid from the container to enter or exit the spout portion. The assembly can include a screen disposed about the liquid inlet for liquid outlet to filter particulate from the liquid prior to the liquid exiting the liquid outlet. The container may be a bottle, carton, or bladder inside of a box, such as a cardboard box or the like.

With reference now to the drawings, and in particular to FIGS. 1-8, a motorized aerator pourer assembly 10 embodying the principles and concepts of the present technology is designated by the reference numeral 10 and will be described in greater detail below. The motorized aerator pourer assembly 10 generally has a housing portion 12 with a receiving area 14 shaped and sized engage a portion of the container at its other fluid outlet port or portion. In one embodiment, the receiving area 14 is configured to receive the neck and opening of a wine bottle or other selected container. The receiving area 14 can be configured to engage the bottle or selected container in a friction fit.

The housing 12 has a wall portion 16 with a fluid inlet opening 18 aligned with the container's fluid outlet. In one embodiment, the receiving area 14 can extend around the top portion of a wine bottle's neck to sealably engage the neck, and to coaxially align the fluid inlet opening 18 with the bottle. The housing's wall portion 16 can include a seal member 20 positioned to sealably engage the portion of the container around its fluid outlet. In one embodiment, the seal member 20 is positioned to sealably engage the top of the bottle neck around its opening, so wine or other liquid exiting the bottle's neck flows through the fluid inlet opening 18 into the spout without leaking at the interface between the container and the assembly.

In the embodiment illustrated in FIG. 2, a hollow rubber fitting 15 with a plurality of seal flanges 17 is connected to the housing 12 and is configured to sealably engage the inside surface of a wine bottle's neck at its opening area, such that the fluid in the bottle can flow from the bottle through the rubber fitting 15 and into the aerator assembly 10. In another embodiment, the receiving area 14 can have a threaded portion that mates with a threaded area of the container, such as the threads on a screw-top wine bottle. Other embodiments can have other mechanisms for secure engagement between the assembly 10 and the container.

The housing 12 contains a drive member, such as an electric motor 22, connected to a power source 23, such as a battery contained in the housing 12. The battery can be a rechargeable battery with a battery connector 23a or the like. In another embodiment, the power source 23 maybe a capacitor or other power source. The power source 23 may also be connectable to exterior power, such as an A/C outlet for recharging or for operation.

The motor 22 is operatively connected to a propeller 24 that projects from the wall portion 16. In the illustrated embodiment, the propeller 24 has a shaft 26 connected to the motor 22 and a plurality of propeller blades 25 extending radially from the shaft 26 at one or more selected angles relative to the shaft. In one embodiment, the propeller can include anywhere from 1 to 10 or more propeller blades on the shaft. The propeller blades 25 are configured as agitators, such that when the electric motor 22 spins the propeller 24 about its longitudinal axis, the propeller blades 25 rotated at a high rate of speed about the longitudinal axis. The propeller blades 25 are oriented at a selected positions relative to the shaft 26 to aggressively agitate liquid passing over the propellers as it flows through the assembly 10. In the illustrated embodiment, a seal 28 is connected to the portion of the shaft 26 and the wall portion 16 where the shaft 26 extends therethrough and connects to the motor 22. This seal 28 prevents fluid, such as wine or other selected liquid, from leaking into the housing and/or the motor 22.

The assembly 10 of the illustrated embodiment includes a spout portion 30, sealably connected to the housing 12 around the wall portion 16. The spout portion 30 has a liquid inlet 32 adjacent to or corresponding to the fluid inlet opening 18 of the wall portion 16. The spout portion 30 also has a liquid outlet 34 spaced apart from the liquid inlet 32. The spout portion 30 includes sidewalls 35 extending between the liquid inlet 32 and the liquid outlet 34 to define a spout 36 with a fluid passageway 38 extending therethrough. The propeller 24 project into the fluid passageway 38, but are offset from the liquid inlet 32. In the illustrated embodiment shown in FIG. 2, the spout 36 includes an inlet baffle 50 that projects at least partially into the fluid passageway 38 adjacent to the liquid inlet 32. This inlet baffle 50 is configured to deflect the flow of liquid entering the spout 36 from the container and direct the liquid flow toward the propeller 24.

The spout 36 of the illustrated embodiment, shown in FIG. 2, also has an outlet baffle 52 projecting inwardly from the sidewalls 35 into the fluid passageway 38 intermediate the distal end of the propeller 24 and the spout's outlet 34. This outlet baffle 52 is positioned and configured to deflect the flow of liquid being pushed by the propeller 24 away from the sidewall 35 to create additional turbulence in the fluid flow prior to the liquid exiting the spout 36 through the liquid outlet 34. This additional turbulence in the flow also helps aeration of the liquid.

The assembly 10 is configured such that when it is sealably attached to a wine bottle or other liquid filled container, and the bottle or container is tipped to pour the liquid out, the liquids flows into the assembly 10 through the liquid inlet 32, along the fluid passageway. 38, and out of the spout 36 through the liquid outlet 34. As the liquid flows through the fluid passageway 38, the liquid passes over the spinning propeller 24. The motor 22 spins the propeller 24 at a very high rate of speed, thereby very aggressively agitating and aerating the flow of liquid within the spout 36 before it exits the spouts liquid outlet 34. In illustrated embodiment, spout is configured to have air within the flow passageway, and as the propeller 24 aggressively mixes the air with the wine or other liquid flowing therethrough, the liquid is hyperaerated (i.e., extremely aggressively aerated). As a result, the wine or other liquid exiting the spout will be hyperdecanted as it is poured into a glass or other suitable receptacle.

In one embodiment, the motor 22, shaft 26 and propellers 24 are configured to spin at a rate in the range of approximately 5000-20,000 RPM. The propeller blades 25 are arranged at selected angles relative to the shaft to cause excessive mixing and/or cavitation within the liquid as it flows along the liquid passageway, thereby hyperaerating the liquid within the spout 36.

In one embodiment, the motor 22 is operatively connected to a manual on/off switch 39 that the operator can activate as they use the assembly 10 to hyperdecant the liquid. In the illustrated embodiment of FIG. 2, the assembly 10 includes a tilt switch 40 movable between off and on positions depending upon the angular orientation of the assembly 10. In one embodiment, the tilt switch 40 is in an “off” position when the assembly 10 and container are in a first orientation (i.e., a non-pouring orientation), such as in a vertical orientation. Accordingly, the motor 22 and propeller 24 are not activated when the tilt switch 40 is in the “off” position. The tilt switch 40 is movable to the “on” position, thereby turning on the motor 22 and rotating the propeller 24 when the assembly and container are tilted passed a selected angle relative to the first position. As an example, when the assembly 10 is attached to the neck of a wine bottle and the wine bottle is vertically oriented, the tilt switch 40 is in the off position. When the wine bottle is tilted so as to cause liquid to flow out of the neck of the wine bottle, the tilt switch 40 is activated and switched on, thereby turning on the motor to aggressively spin the propeller 24 for aeration of the wine moving through the spout 36.

The assembly 10 can also include a light 54, such as an LED light or the like, coupled to the power source 23 and configured to be turned on and off, so as to illuminate at least a portion of the assembly 10. In the illustrated embodiment, the light 54 is connected to the housing exterior of and adjacent to the base of the spout 36 and positioned to illuminate at least a portion of the spout 36 and/or the liquid outlet through which the aerated liquid will flow. In one embodiment, the light 54 can be coupled to the tilt switch 40 so as to turn on when the tilt switch 40 is moved to the on position. In one embodiment, the spout 36 is transparent or translucent, and the light 54 can illuminate the inside area of the spout 36, so as to allow a user to watch the flow of liquid and aeration thereof as it passes through the spout 36. In another embodiment, the light 54 can be positioned to illuminate the liquid outlet area so as to also illuminate a portion of the glass or other receptacle into which the hyperdecanted liquid is being poured.

In the embodiment, wherein the assembly 10 is sealably and releasably attached to a wine bottle, operation of the motorized aerator assembly 10 is conveniently performed by holding the bottle in one hand and tilting the bottle toward the receiving glass. As the bottle is tilted the tilt switch 40 activates the LED light 54 and the spinning of the electric motor 22 and propeller 24 as the wine flows over the spinning propeller blades 25 and vigorously splashes and mixes with air within the spout chamber. The spin direction of the propeller blades 25 propels the wine towards the spout exit.

A second embodiment of the motorized aerator pourer is seen in FIGS. 9-11. Where the motorized aerator pourer assembly 100 is removably attached to a box of wine or other liquid. The assembly has a hollow attachment portion 102 that releasably and sealably attached to the box at its outlet port, such that liquid flowing from the box's outlet port flows into the hollow attachment portion 102. The hollow attachment portion 100 to is connected to a housing 104 that contains the motor 106 and propeller 108. The housing 104 defines a spout 105 that receives a flow of the liquid from the hollow attachment portion 100, the liquid flows along the fluid path to the housing's outlet 110. The motor 106 and propeller 108 are coaxially aligned with the outlet 110, and the propeller 108 is positioned in fluid path. When the motor 106 is turned on or otherwise activated, the propeller 108 spins at a very high rotational rate so as to hyperaerate the flow of liquid in the fluid path prior to exiting through the outlet 110. In the illustrated embodiment, the assembly 100 has an actuation knob 112 rotatably connected to the top of the housing. The actuation knob 112 is movable between an open/on position and a closed/off position. Rotation or actuation of the novel 112 is configured to turn on or off the motor 106, thereby turning on or off the propeller 108. When the knob 112 is in the closed/off position, the knob blocks the fluid from flowing through the housing's fluid path, such that the liquid is not dispensed from the container. Knob 112 is coupled to the power source 120, such that when the knob 112 is in the closed/off position, the motor 106 is electrically disconnected from the power source 120.

When the knob 112 is in the open/on position, the knob 112 is positioned relative to the housing to allow the liquid to flow along the fluid path to be dispensed from the container. In addition, when the knob is in the open/on position, a switch is closed so as to electrically interconnect the motor 106 with the power source 120, thereby causing the propeller to spin within the housing so as to hyperaerate the liquid flowing toward the assembly's outlet. In one embodiment, the knob 112 is configured to move between the closed/off position and the open/on position upon rotating the knob through a range of approximately 90 degrees. When the knob 112 is in the closed/off position and is turned, for example, 90 degrees to the right, this rotation simultaneously engages the battery connectors to the motor terminal to begin the motor 106 and propeller 108 spinning while the wine flows from the container. The wine mixes with air while in the spout chamber and exits through the spout opening. By turning the knob 90 degrees to the left will simultaneously turn off the motor 106 and close the flow of wine from the box.

From the foregoing, it will be appreciated that specific embodiments of the invention have been described herein for purposes of illustration, but that various modifications may be made without deviating from the spirit and scope of the invention. Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the invention. Accordingly, the disclosure and associated technology can encompass other embodiments not expressly shown or described herein. Thus, the disclosure is not limited except as by the appended claims.

I claim:

1. A motorized aerator pourer comprising: a pouring assembly being removably engaged to a container for pouring liquids from a container, said motorized aerator pourer assembly including a plurality of rotating propellers through which liquid is passed, an electric motor spins the propellers at sufficient rate to cause air mixing with the liquid, the assembly includes a spout through which liquid is poured from the liquid container.

2. The motorized aerator pourer as described in claim 1, wherein said propellers number from 1 to 10.

3. The motorized aerator pourer as described in claim 1, wherein said motor is powered by rechargeable batteries or capacitor.

4. The motorized aerator pourer as described in claim 1, wherein said motor is controlled by the tilt switch.

5. The motorized aerator pourer as described in claim 1, wherein a LED light is controlled by the tilt switch.

6. The motorized aerator pourer as described in claim 1, wherein said upper portion has an open top end and has at least one side wall having at least one opening to allow liquid from the container to be passed through mixing chamber and out spout exit.

7. The motorized aerator pourer as described in claim 6, wherein said lower portion has an air mixing chamber therein.

8. The motorized aerator pourer as described in claim 6, wherein said lower portion also has at least 2 openings to facilitate cleaning of said air chamber spout.

9. The motorized aerator pourer as described in claim 6, wherein said aerating assembly also includes a cap which is removably disposed over said open bottom to prevent liquid from the bottle to enter said air chamber during use.

10. The motorized aerator pourer as described in claim 6, wherein said spout exit has a fine metal screen to filter particulate from the liquid as it exits the spout.

11. The motorized aerator pourer as described in claim 6, wherein said liquid container is a bottle.

12. The motorized aerator pourer as described in claim 6, wherein said liquid container is a plastic bladder inside a cardboard box.
